(19) United States
(12) Patent Application Publication
(10) Pub. No.: US 2014/0055354 A1
(43) Pub. Date: Feb. 27, 2014

(54) MULTI-MODE INTERACTIVE PROJECTION SYSTEM, POINTING DEVICE THEREOF, AND CONTROL METHOD THEREOF

(71) Applicant: EVEREST DISPLAY INC., Hsinchu City (TW)

(72) Inventors: Hei-Tai HONG, Hsinchu County (TW); Fu-Hsiung LEE, Hsinchu City (TW); Yu-Chi LIN, Hsinchu City (TW); Shih-Chieh LU, Hsinchu City (TW)

(73) Assignee: EVEREST DISPLAY INC., Hsinchu City (TW)

(21) Appl. No.: 13/714,552

(22) Filed: Dec. 14, 2012

(30) Foreign Application Priority Data
Aug. 22, 2012 (TW) 101130397

(51) Int. Cl. G06F 3/033

(52) U.S. Cl. CPC G06F 3/033
USPC 345/157

(57) ABSTRACT

A multi-mode interactive projection system includes a pointing device, an infrared capturing device, and a projection device. A timing generation module of the pointing device generates several timing signals, and controls the pointing device to execute one light emitting mode according to one timing signal. A light emitting module of the pointing device is controlled by the timing generation module, and generates infrared in a light emitting time according to the executed light emitting mode. In a detection time, the light emitting time corresponds to one light emitting mode. The infrared capturing device periodically captures the infrared. A projection module is controlled by a background image and a writing image outputted by a host device, and projects the image to screen. The host device determines the light emitting mode and continuously captures coordinate points of infrared by the infrared capturing device in the detection time.

### BACKGROUND

1. Technical Field

The present disclosure relates to an interactive projection system; in particular, to a multi-mode interactive projection system, a pointing device thereof, and a control method thereof.

2. Description of Related Art

Because of the appearance of the presentation software, people may edit and store presentation data into a host device in advance, and use a projection device to project a background image on a projection screen by an electrical connection to the projection device, for generating a projection frame corresponding to the background image.

Conventionally, when the presentation is taking, for making the audiences quickly understanding the contents of the presentation, the reporter may use a pointing device to emit laser light, for clearly pointing or circling the key points on the projection frame. In an interactive projection system, the track pointed or circled on the projection screen by the infrared may correspondingly be displayed on the projection frame.

However, if the reporter needs to modify the movement track pointed or circled on the projection frame by the infrared, another pointing device with other functions may be required for the modification, which causes inconveniences of operations. In addition, when the first pointing device and the second pointing device are used at the same time, the operation modes may be wrongly determined.

Therefore, a pointing device of an interactive projection system which integrates several operation modes is required, so as to make the host device execute different operation functions corresponding to different operation modes, and to modify the movement track of the infrared displayed on the projection frame accordingly.

### SUMMARY

The present disclosure discloses a multi-mode interactive projection system, a pointing device thereof, and a control method thereof. The pointing device has several light emitting modes corresponding to several light emitting times, which may make the host device recognize the light emitting mode executed by the pointing device, for executing corresponding function of the light emitting mode.

The embodiment of the present disclosure provides a multi-mode interactive projection system which includes a pointing device, an infrared capturing device, and a projection device. The pointing device has several light emitting modes, and includes a timing generation module and a light emitting module. The timing generation module is for generating several timing signals, and for controlling the pointing device to execute one of the light emitting modes according to one of the timing signals. The light emitting module is controlled by the timing generation module for generating an infrared with a light emitting time according to the executed light emitting mode. Moreover, in a detection time, the light emitting time corresponds to one of the light emitting modes. The infrared capturing device periodically captures the infrared projected on a projection screen. The projection device is controlled by the combination of the background image and the writing image outputted by the host device, and projects the combination of the background image and the writing image to the projection screen for generating a projection frame. Thus, within the detection time, the host device determines the light emitting mode executed by the pointing device and acquires the coordinate points of the infrared by the infrared capturing device.

The present disclosure provides a control method of a multi-mode interactive projection system. The method is applied for recognizing the light emitting modes of the pointing device, and within a detection time, each light emitting mode is correspondence to one of the light emitting times. The method includes generating a projection frame, executing one of the light emitting modes of the pointing device, and periodically capturing the infrared projected on the projection screen. In addition, according to the infrared projected on the projection screen in the detection time, the light emitting mode executed by the pointing device is determined, and the coordinate points of the infrared are continuously acquired before the detection time elapses and after the light emitting time has elapsed for a period.

The present disclosure provides a pointing device having a physical erasure part and a light emitting module. The physical erasure part is for erasing a physical writing written on the projection screen by a writing device. The light emitting module selectively generates infrared. Thus, the infrared projected on the projection screen is captured by the infrared capturing device, and a track data is generated accordingly before the detection time elapses and after the light emitting time has elapsed for a period. The host device may remove the writing image within a predetermined area according to the track data.

On the basis of the above, the present disclosure provides a multi-mode interactive projection system, a pointing device and a control method thereof. Through the correspondence between several light emitting modes and light emitting times of the pointing device, the host device may be able to recognize the light emitting mode executed by the pointing device within the predetermined detection time, and to execute corresponding functions of the light emitting mode. Therefore, in addition to integrating several operation functions executed by software, the pointing device of the present disclosure may also have the function of physical erasure, which increases the practical usability thereof.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 shows an operation diagram of a multi-mode interactive projection system according to an embodiment of the present disclosure;

FIG. 2 shows a function block diagram of a multi-mode interactive projection system according to an embodiment of the present disclosure;

FIG. 3 shows another one schematic diagram of light emitting modes of a pointing device determined by a multi-mode interactive projection system according to the present disclosure;

FIG. 4 shows a schematic diagram of another type of a pointing device according to the present disclosure; and

FIG. 5 shows a flow chart of a control method of a multi-mode interactive projection system according to an embodiment of the present disclosure.

### DETAILED DESCRIPTION OF EMBODIMENTS

[An Embodiment of a Multi-Mode Interactive Projection System]

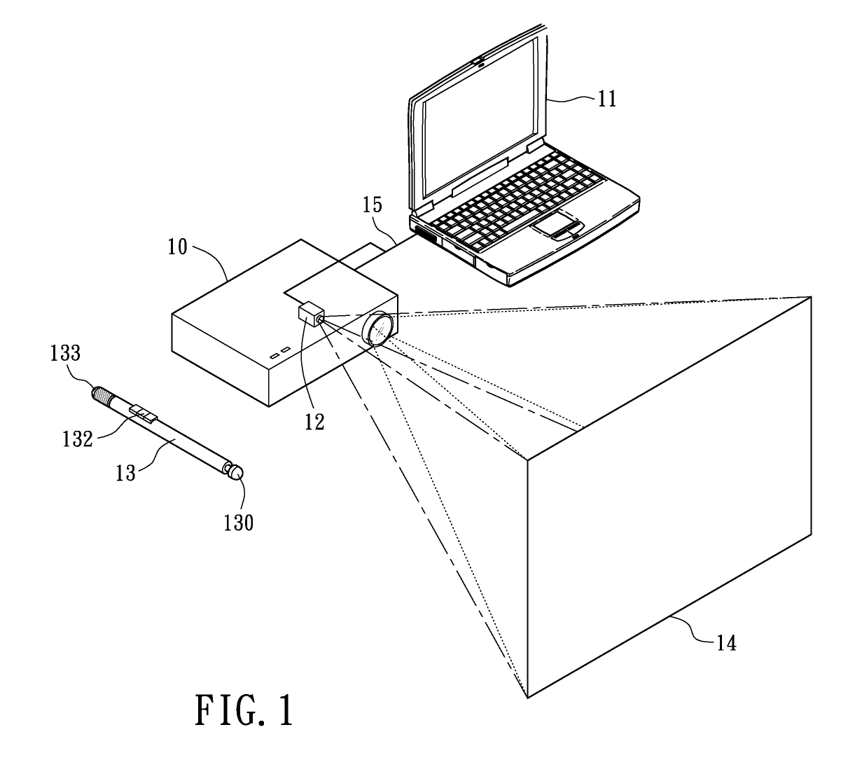

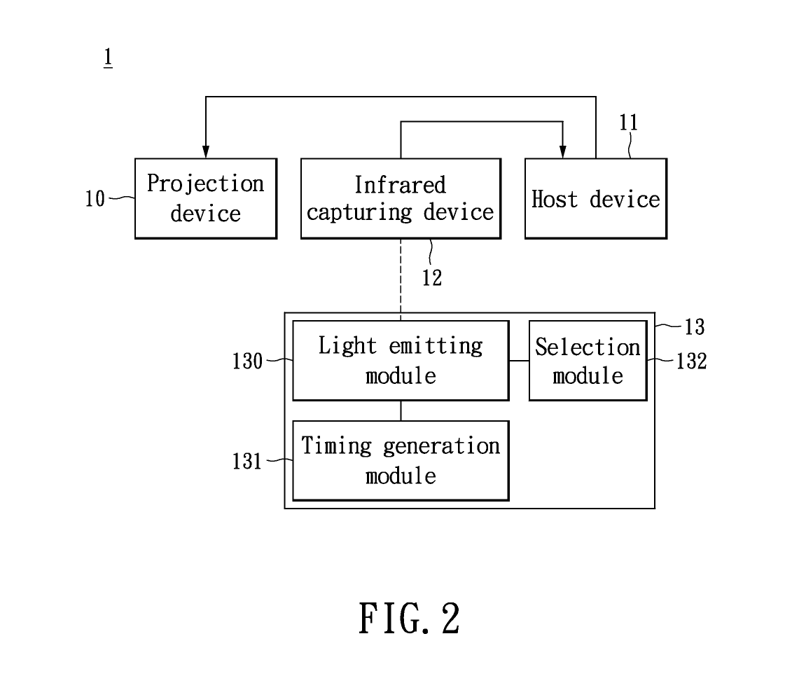

Referring to both of FIGS. 1 and 2, FIG. 1 shows an operation diagram of a multi-mode interactive projection system according to an embodiment of the present disclosure, and FIG. 2 shows a block diagram of a multi-mode interactive projection system according to an embodiment of the present disclosure. As shown in FIG. 1, the multi-mode interactive projection system 1 includes a projection device 10, a host device 11, an infrared capturing device 12, a pointing device 13, and a projection screen 14. The host device 11 (such as a tablet computer or a notebook computer) transmits data with the projection device 10 through a transmission path 15, which makes the data stored in the host device 11 be able to be projected on the projection screen 14 as a background image through the projection device 10, for generating corresponding projection frame. The infrared capturing device 12 transmits the image of the captured infrared to the host device 11 through the transmission path 15, which makes the host device be able to execute at least one of the subsequent processes.

In addition, in the multi-mode interactive projection system 1, the host device 11 may correspondingly generate a writing image according to the movement track of the infrared generated by the pointing device 13, and outputs the combination of the writing image and the background image to the projection device 10. Thus, the projection device 10 may be able to project the combination of the writing image and background image on the projection screen 14 for generating a projection frame. In other words, before using the pointing device 13, the projection frame projected by the projection device 10 are only the background image outputted by the host device 11.

Generally, the projection screen 14 is located at the front of the projection aperture of the projection device 10, and the background of the projection screen 14 is usually white, such that the projection device 10 can project background image on the projection screen 14 for generating the projection frame. Practically, the projection screen 14 may be an electrical whiteboard or a conventional whiteboard, and the projection screen 14 is not restricted by the present disclosure. It's worth noting that the projection screen 14 is only a projectable surface without performing any actual actions. Thus, the projection screen 14 is not shown in the block diagram of FIG. 2; however, it does not mean that the projection screen 14 cannot be included in the multi-mode interactive projection system 1.

The pointing device 13 has several light emitting modes; each of them corresponds to a function for being executed by the host device 11. The user may make the pointing device 13 select one of the light emitting modes by triggering a selection module 132, and make the light emitting module 130 disposed at front end of the pointing device 13 generate an infrared accordingly. The infrared is invisible light.

Practically, the pointing device 13 usually has a pen-shaped housing, which may be conveniently used by users. However, the shape of the pointing device 13 is not restricted thereby. In addition, the pointing device 13 may further have a physical erasure part 133 which is for erasing a physical writing written on the projection screen 14 by a writing device (such as a whiteboard pen). Although the pointing device 13 in FIG. 1 has the physical erasure part 133, the disposition of the physical erasure part 133 is not restricted by the present disclosure.

It is worth noting that the transmission path 15 may be a physical transmission wire or a wireless transmission manner using wireless communication protocols. Though the transmission path 15 in FIG. 1 only shows one kind of transmission cable, the type of the transmission path 15 is not for limiting the data transmission manners between the host device 11, the projection device 10, and the infrared capturing device 12. The following descriptions are the detail explanations of the components in the multi-mode interactive projection system 1.

As shown in FIG. 2, the pointing device 13 includes a light emitting module 130, a timing generation module 131, and a selection module 132. The light emitting module 130 is electrically connected with the timing generation module 131 and the selection module 132. The timing generation module 131 is for generating several timing signals and controlling the pointing device 13 to execute one of the light emitting modes according to one of the timing signals. The light emitting module 130 is controlled by the timing generation module 131, for generating infrared with a predetermined time according to the executed light emitting mode. In addition, the timing generation module 131 is controlled by the selection module 132 of the pointing device 13, such that the light emitting module 130 selectively generates the infrared according to one of the light emitting modes.

It's worth noting that, in a predetermined detection time DET_T, the light emitting time of the infrared generated by the pointing device 13 corresponds to one of the light emitting modes. In other words, in the predetermined detection time DET_T, each light emitting mode has the corresponding light emitting time, for example, the light emitting time of a first light emitting mode MODE 1 is T1, the light emitting time of a second light emitting mode MODE 2 is T2.

Practically, for making the pointing device 13 have different light emitting times, the timing generation module 131 may be a PIC (Peripheral Interface Controller) microcontroller. The PIC microcontroller may control the period length of the light emitting time. However, the scope of the present disclosure is not limited thereby.

The selection module 132 is for driving the pointing device 13 to selectively execute one of the light emitting modes. In other words, the selection module 132 is for driving the pointing device 13 to execute the function of the selected light emitting mode. Practically, the selection module 132 may be a switch or several buttons.

In addition, the selection module 132 may be several touch sensing units, each of the touch sensing units corresponds to one of the light emitting modes and a touch sensing area at the pointing device 13. For example, one of the touch sensing units may be disposed at the light emitting module 130 of the pointing device 13, and another of the touch sensing units may be disposed at the physical erasure part 133 of the pointing device 13, however, the placement of the touch sensing units is not limited thereby. When one of the touch sensing units is triggered, the host device 11 is controlled to execute the function of the corresponding light emitting mode.

The projection device 10 is controlled by the combination of the background image and the writing image outputted by the host device 11, and projects the combination of the background image and writing image on the projection screen 14 for generating the projection frames.

The infrared capturing device 12 is for periodically capturing the infrared projected on the projection screen 14. Generally, the infrared capturing device 12 is usually disposed at the same side as the projection aperture. The size of the image capturing area is about the same size as the projection screen 14, for wholly capturing the infrared projected on the projection screen 14.

Practically, the infrared capturing device 12 may be an image-sensing component made by a charge coupled device (CCD) or a complementary metal oxide semiconductor (CMOS), but the type of the infrared capturing device 12 is not limited thereby. In addition, although the infrared capturing device 12 and the projection device 10 are independently workable devices, the one skilled in the art may design and combine the infrared capturing device 12 and the projection device 10 into a single device which has both the image projection and infrared capturing functions.

In addition, the embodiments of the present disclosure do not limit the wavelength of the captured infrared. For example, the infrared capturing device 12 may capture the infrared within the wavelength between 0.75 μm to 1.4 μm (near infrared band) or between 1.4 μm to 3 μm (short wavelength infrared band).

It's worth noting that the image of the infrared captured by the infrared capturing device 12 does not always need to be projected on the projection screen 14. The image is able to be captured as long as the image is projected within the place which lies in the capturing area of the infrared capturing device 12 (such as the region in the dotted line which shows the extendable area of the lens of the infrared capturing device 12 in FIG. 1).

The host device 11 receives the image captured by the infrared capturing device 12, and determines the light emitting mode executed by the pointing device 13 according to the infrared projected on the projection screen 14 within the detection time DET_T. In addition, the host device 11 also continuously receives the coordinate point of the infrared according to the infrared projected on the projection screen 14 before the detection time elapses and after the light emitting time has elapsed for a period, so as to make the host device 11 generate the track data accordingly. Thus, the host device 11 modifies the writing image according to the track data and the executed light emitting mode.

In actual operations, the host device 11 may execute coordinate calculation toward the image captured by the infrared capturing device 12 within a time period, for calculating the coordinate points of the infrared projected on the projection screen 14 within the time period. Thus, the host device 11 may execute the functions of the corresponding light emitting mode executed by the pointing device 13 accordingly.

For example, the first light emitting mode MODE 1 of the pointing device 13 may be a writing function, and the second light emitting mode MODE 2 may be an erasing function. In the first light emitting mode MODE 1, the track data may order the host device 11 to control the projection device 10 for displaying the movement track of the infrared. In other words, the track data may order the host device 11 to display the movement track of the infrared on the writing image. In the second light emitting mode MODE 2, the track data may order the host device 11 to erase a predetermined area of writing image according to the movement track of the infrared. The predetermined area may be adjusted according to actual requirements. In addition, the user may also set the third light emitting mode MODE 3 as the functions of selection, cutting, posting, rotation, or size adjustment, and it's not limited by the present disclosure.

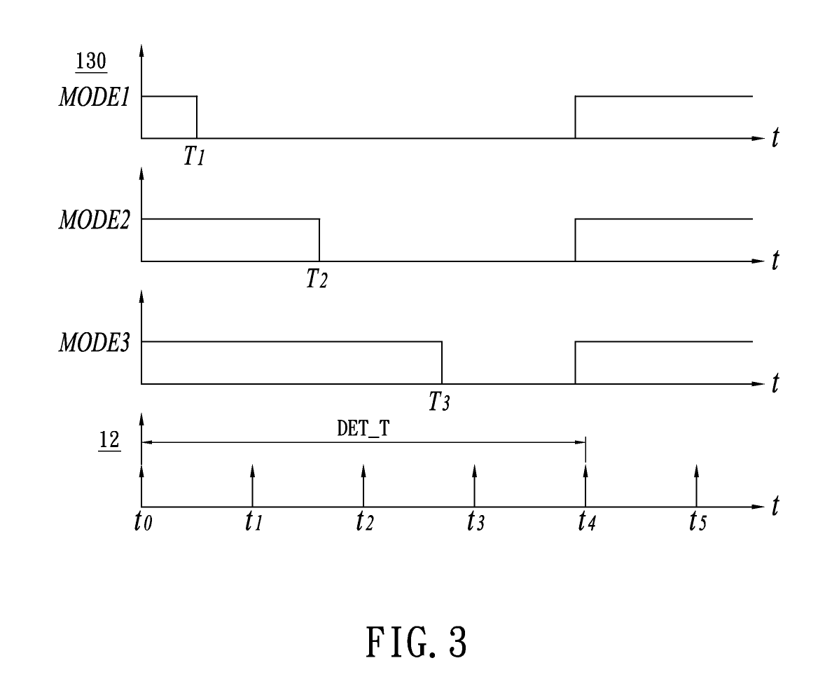

For explaining the actual operation of determining which light emitting mode is executed by the pointing device 13 according to the system 1 disclosed by the present disclosure, please refer to FIG. 3. FIG. 3 shows a schematic diagram of the multi-mode interactive projection system for determining the light emitting mode of the pointing device according to the present disclosure.

As shown in FIG. 3, assuming that the pointing device 13 has three light emitting modes which include the first light emitting mode MODE 1, the second light emitting mode MODE 2, and the third light emitting mode MODE 3. At the beginning when the light emitting module 130 generates the infrared, the initial statuses and the light emitting times of each of the light emitting modes are different from one another. For example, the light emitting time of the first light emitting mode MODE 1 is T1, the light emitting time of the second light emitting mode MODE 2 is T2, and the light emitting time of the third light emitting mode MODE 3 is T3. Thus, by periodically (t0, t1, t2 . . . ) capturing the properties of the infrared projected on the projection screen 14, the infrared capturing device 12 may acquire the times that the infrared are detected within a predetermined detection time DET_T.

If the pointing device 13 uses the second light emitting mode MODE 2 according to the selection of the selection module 132, in the detection time DET_T, the host device 11 may determine the light emitting mode executed by the pointing device 13 according to the times that the infrared is detected, and may execute the functions corresponding to the executed light emitting mode.

In addition, after the detection time DET_T when the system 1 has already determined the light emitting mode executed by the pointing device 13, the light emitting module 130 may continuously generate the infrared, and the infrared capturing device 12 captures the infrared projected on the projection screen 14 until the light emitting module 130 stops generating infrared.

It is noted that, the light emitting module 130 may generate the infrared before the detection time DET_T elapses and after the light emitting time, for example T1 has elapsed for a period (i.e. the period t1-t0). When the user uses the pointing device to pain the line after the light emitting mode is determined, the infrared may be generated before the detection time DET_T elapses and after the light emitting time, for example T1 has elapsed for a period (i.e. the period t1-t0), so as to prevent the missing point.

Generally, if the capturing frequency of the infrared capturing device 12 is 90 frames/sec, the average time of capturing the image on the projection screen 14 for one time is about 11 msec. Thus, the infrared capturing device 12 may execute the capturing function at t1 (which is 11 msec), t2 (which is 22 msec), t3 (which is 33 msec) . . . .

Practically, without influencing the determination of the infrared, the capturing frequency of the infrared capturing device 12 may be about 50 frames/sec to 90 frames/sec, which makes the average time of capturing infrared once lie in the range between 11 msec to 20 msec, and the detection time may be set lower than 50 msec, but they're not restricted thereby. In addition, when the infrared capturing device 12 does not capture the infrared within a predetermined time (such as 200 msec), it may determine that the pointing device 13 stops. The predetermined time may be adjusted according to the actual situations.

It's worth noting that, although the pointing device 13 in FIG. 3 shows only three light emitting modes, the number of light emitting modes of the pointing device 13 is not limited thereby, and the user may expend the number of the light emitting modes and modify the light emitting time of the light emitting modes according to actual needs. In addition, the capturing frequency of the infrared capturing device 12 is not limited by the present disclosure, and may be freely designed by the users according to the number of the used light emitting modes.

Although the embodiments of the present disclosure show that the calculation of the coordinate points of the infrared and the determination of the executing light emitting mode of the pointing device 13 are processed by the host device 11, the one skilled in the art may integrate the two functions into the processing module (not shown in FIG. 2) of the projection device 10, which makes the projection device 10 has both the functions of determining the executing light emitting mode of the pointing device and calculating the coordinate points of the infrared.

In addition, although the system 1 disclosed by the embodiment of the present disclosure only uses one pointing device 13, the one skilled in the art may know that the disclosed system 1 may also be used at the situation having more than one pointing devices 13. Thus, the number of using pointing devices 13 is not restricted by the present disclosure.

[Another Embodiment of a Pointing Device]

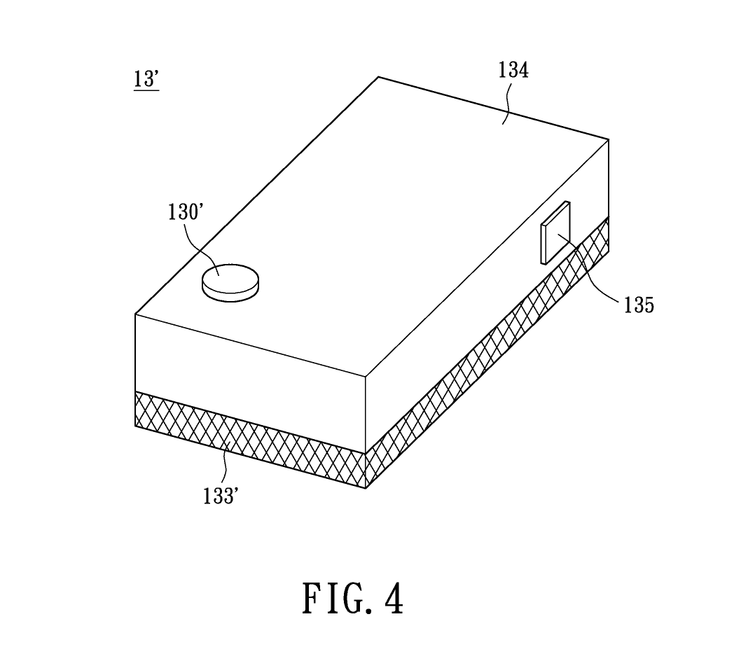

The pointing device 13 may further be designed as a board eraser. Please refer to FIG. 4 which shows another type of the pointing device according to the present disclosure. As shown in FIG. 4, the pointing device 13′ is a physical board eraser and has a light emitting module 130′, a physical erasure part 133′, a holding part 134, and a button 135. The functions of the light emitting module 130′ and the physical erasure part 133′ are the same as their counterparts shown above, and they're not repeatedly described.

The holding part 134 is connected with the physical erasure part 133′, for providing the holding space to the user when it is operated. The holding part 134 has at least the light emitting module 130′ and the button 135. The button 135 is the triggering switch of the light emitting module 130′. Thus, when the button 135 is triggered, the light emitting module 130′ may generate infrared points. In addition, the present disclosure does not restrict the type of the button 135.

It's worth noting that the pointing device 13′ according to the embodiment of the present disclosure may further include a touch sensing unit (not shown in FIG. 4). Generally, the touch sensing unit is usually disposed between the physical erasure part 133′ and the holding part 134, which makes the touch sensing unit drive the light emitting module 130′ to generate infrared-light points when the physical erasure part 133′ touches the projection screen 14. The present disclosure does not limit the disposing place of the touch sensing unit.

[Embodiment of a Control Method of a Multi-Mode Interactive Projection System]

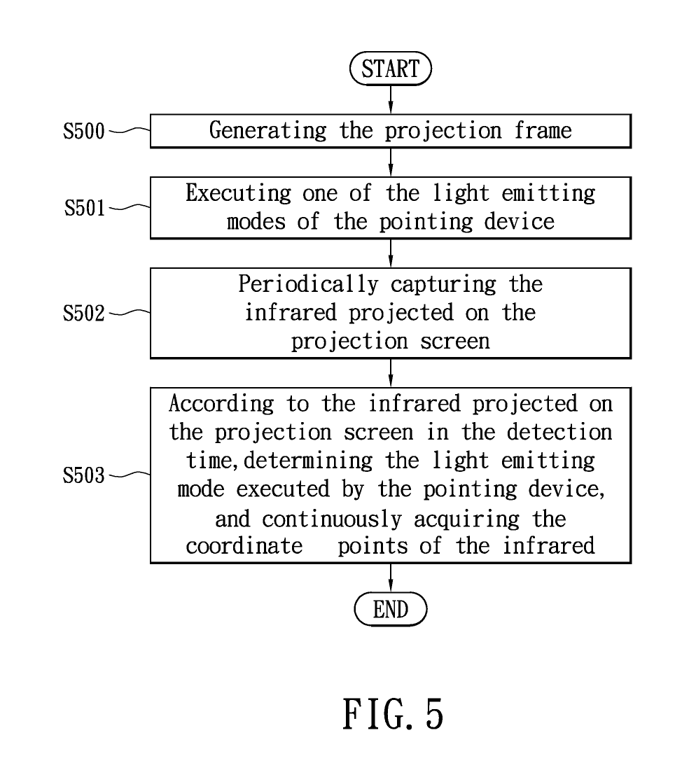

Please refer to FIG. 2 along with FIG. 5. FIG. 5 shows a flow chart of a control method of a multi-mode interactive projection system according to an embodiment of the present disclosure. The control method is applied to recognize several light emitting modes of the pointing device 13. Moreover, within a detection time, each of the light emitting modes is correspondence to one of the light emitting times.

As shown in FIG. 5, the step S500 includes electrically connecting the host device 11 with the projection device 10, which makes the combination of the background image and the writing image outputted by the host device 11 be able to be outputted to the projection screen 14, for generating the projection frames. In step S501, the pointing device 13 executes one of the light emitting modes for making the light emitting module 130 generate infrared.

In step S502, the infrared capturing device 12 of the projection device 10 periodically captures the infrared projected on the projection screen 14. In step S503, the host device 11 may determine the light emitting mode executed by the pointing device 13 according to the infrared projected on the projection screen 14 in the detection time DET_T, and may continuously acquire the coordinate points of the infrared.

In the step of continuously acquiring the coordinate points of the infrared, further includes generating a track data according to the coordinate points of the infrared and modifying a writing image according to the track data and the executing light emitting mode.

Therefore, by the design of several light emitting modes of the pointing device 13, the control method according to the embodiment of the present disclosure may make the host device 11 execute corresponding functions according to different light emitting modes.

[The Possible Efficacies of the Embodiments]

On the basis of the above, the present disclosure provides a multi-mode interactive projection system, a pointing device, and a control method thereof. By the correspondence between the several light emitting modes and the light emitting times of the pointing device, the host device may be able to recognize the light emitting mode executed by the pointing device within a predetermined detection time, and calculates the coordinate points of the infrared according to the infrared projected on the projection screen. Thus, the host device may modify the writing image outputted from the host device to the projection device according to the coordinate points of the infrared and the functions of corresponding light emitting mode. In addition to the integration of the several operational functions by using software, the pointing device according to the present disclosure may further have the function of physical erasing, which increases the practical usability thereby.

Some modifications of these examples, as well as other possibilities will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims.

What is claimed is:

1. A multi-mode interactive projection system, comprising:
a pointing device having a plurality of light emitting modes, including:
a timing generation module for generating a plurality of timing signals, and for controlling the pointing device to execute one of the light emitting modes according to one of the timing signals; and
a light emitting module controlled by the timing generation module, for generating an infrared with a light emitting time according to the light emitting mode executed thereby, and in a detection time, the light emitting time corresponds to one of the light emitting modes;
an infrared capturing device for periodically capturing the infrared projected on a projection screen; and
a projection device controlled by a combination of a background image and a writing image outputted by a host device, and projecting the combination of the background image and the writing image to the projection screen for generating a projection frame;
wherein the host device determines the light emitting mode executed by the pointing device and continuously acquires coordinate points of the infrared by the infrared capturing device in the detection time.

2. The multi-mode interactive projection system according to claim 1, wherein the host device further generates a track data according to the coordinate points of the infrared, and modifies the writing image according to the track data and the light emitting mode executed thereby.

3. The multi-mode interactive projection system according to claim 2, wherein the track data is generated before the detection time elapses and after the light emitting time has elapsed for a period.

4. The multi-mode interactive projection system according to claim 2, wherein the light emitting modes include a first light emitting mode and a second light emitting mode; in the first light emitting mode, the track data orders the host device to display a movement track of the infrared at the writing image, and in the second light emitting mode, the track data orders the host device to removing the writing image within a predetermined area according to the movement track of the infrared.

5. The multi-mode interactive projection system according to claim 1, wherein the pointing device further includes a selection module for driving the pointing device to selectively execute one of the light emitting modes.

6. The multi-mode interactive projection system according to claim 1, wherein the pointing device further includes a physical erasure part for erasing a physical writing written on the projection screen by a writing device.

7. The multi-mode interactive projection system according to claim 1, wherein the detection time is no more than 50 milliseconds.

8. A control method of a multi-mode interactive projection system, for recognizing a plurality of light emitting modes of a pointing device, and in a detection time, each light emitting mode corresponds to one of a plurality of light emitting times, the control method comprising:
generating a projection frame;
executing one of the light emitting modes of the pointing device;
periodically capturing the infrared projected on a projection screen; and
according to the infrared projected on the projection screen in the detection time, determining the light emitting mode executed by the pointing device and continuously acquiring a coordinate point of the infrared.

9. The control method of the multi-mode interactive projection system according to claim 8, wherein the step of continuously acquiring the coordinate points of the infrared further includes generating a track data according to the coordinate points of the infrared and modifying a writing image according to the track data and the light emitting mode.

10. The control method of the multi-mode interactive projection system according to claim 9, wherein the track data is generated before the detection time elapses and after the light emitting time has elapsed for a period.

11. The control method of the multi-mode interactive projection system according to claim 9, wherein the light emitting modes include a first light emitting mode and a second light emitting mode; in the first light emitting mode, a movement track of the infrared is displayed on the writing image, and in the second light emitting mode, the writing image within a predetermined area is removed according to the movement track of the infrared.

12. The control method of the multi-mode interactive projection system according to claim 8, wherein the pointing device further includes a selection module for driving the pointing device to selectively execute one of the light emitting modes.

13. The control method of the multi-mode interactive projection system according to claim 8, wherein the pointing device further includes a physical erasure part for erasing a physical writing written on the projection screen by a writing device.

14. The control method of the multi-mode interactive projection system according to claim 8, wherein the detection time is no more than 50 milliseconds.

15. A pointing device, comprising:
a physical erasure part for erasing a physical writing written on a projection screen by a writing device; and
a light emitting module for selectively generating an infrared;
wherein the infrared projected on the projection screen is captured by an infrared capturing device, and a track data is generated accordingly, for making a host device remove a writing image in a predetermined area according to the track data.

16. The pointing device according to claim 15, wherein the pointing device further has a button, and when the button is triggered, the light emitting module generates the infrared.

17. The pointing device according to claim 15, wherein the pointing device further has a touch sensing unit, and when the physical erasure part touches the screen, the touch sensing unit drives the light emitting module for generating the infrared.
